(19) United States
(12) Patent Application Publication
(10) Pub. No.: US 2009/0046691 A1
(43) Pub. Date: Feb. 19, 2009

(54) Robust scheduling request mechanism in a cellular environment

(75) Inventors: Juha Karjalainen, Oulu (FI); Markku J. Vainikka, Kiviniemi (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/228,878

(22) Filed: Aug. 15, 2008

Related U.S. Application Data
(60) Provisional application No. 60/955,926, filed on Aug. 15, 2007.

(51) Int. Cl. H04J 13/00

(52) U.S. Cl. 370/342

(57) ABSTRACT

A sequence restriction method is shown applicable for an uplink (UL) scheduling request in order to increase resistance against frequency error. A cyclic shift restriction is applied to the orthogonal cover codes used in a scheduling request structure. For an uplink scheduling request, the transmitter selects sequences which tolerate high Dopplers and/or frequency errors. Performance of scheduling requests is improved for UEs having high Doppler/frequency error (reduces false alarm rate). In addition, the improvement is obtained without changing the scheduling request structure. As a result, the multiplexing capacity of scheduling requests is not reduced in environments where there are no high speed UEs.

### CROSS-REFERENCE TO RELATED APPLICATION

This application claims priority from U.S. Provisional Application Ser. Number 60/955,926 filed Aug. 15, 2007.

### BACKGROUND OF THE INVENTION

1. Technical Field

The invention relates to reducing the effect of Doppler and/or high frequency errors in a cellular system.

2. Discussion of Related Art

Abbreviations

| | |
|---|---|
| 3GPP | Third generation partnership project |
| CDM | Code Division Multiplexing |
| CAZAC | Constant Amplitude Zero Autocorrelation |
| LTE | Long Term Evolution |
| SNR | Signal to Noise Ratio |
| SR | Scheduling Request |
| UL | Uplink |
| UTRAN | Universal Terrestrial Radio Access Network |
| UL SR | Uplink Scheduling Request |

This invention arose in the context of developments underway in the UL part of UTRAN long term evolution (LTE) often referred as 3.9G but is not limited to that context.

In 3G LTE a scheduling request channel for the uplink is in the process of being defined. The current discussion and decision is that the channel will utilize a code domain spreading and multiplexing between users. The performance of the channel in a multi-access scenario has been presented in 3GPP document R1-071663. The used scrambling codes are proposed to be Zadoff-Chu sequences. The basic idea of the code domain spreading and multiplexing is shown in FIG. 1. The seven resource elements shown correspond to seven symbols in one slot on one subcarrier. Thus, within a slot in LTE, 7 SC-FDMA symbols will exist for the scheduling request channel. The shown slot structure is replicated for eleven additional subcarriers to form a resource block of 12*7=84 resource elements similar to that described for 3GPP TS 36.211. Each SC-FDMA symbol consists of complex valued symbols. In the LTE example for the scheduling request channel, each SC-FDMA symbol consists of 12 complex valued symbols.

A block diagram of a transmitter for the scheduling request channel is shown in FIG. 3. The transmitter produces different cyclic shifts of CAZAC (Zadoff-Chu sequences) sequences. Several definitions for CAZAC sequences exist. Each definition allows for several root sequences of the same length to be created. An example of one definition is given in Section 6.7.2 of 3GPP TS 36.211. Although the example is for the PRACH channel, the different concepts are defined by the example as follows:

### “6.7.2 Preamble Sequence Generation

The random access preambles are generated from Zadoff-Chu sequences with zero correlation zone, ZC-ZCZ, generated from one or several root Zadoff-Chu sequences. The network configures the set of preamble sequences the UE is allowed to use.

The u^{th} root Zadoff-Chu sequence is defined by

$${x}_{u} ( n ) = {e}^{- j \frac{π un ( n + 1 )}{{N}_{ZC}}} , 0 \leq n \leq {N}_{ZC} - 1$$

where the length N_{ZC} of the Zadoff-Chu sequence is given by Table 14. From the u^{th} root Zadoff-Chu sequence, random access preambles with zero correlation zone are defined by cyclic shifts of multiples of N_{CS} according to

x_{u,v}(n)=xᵤ((n+vN_{CS})mod N_{ZC})

where N_{CS} iS given by Table 14.

TABLE 14
Random access preamble sequence parameters.

| | | | | | Preamble |
|---|---|---|---|---|---|
| | | | | Number of | sequences |
| Frame structure | | N_{ZC} | N_{CS} | preambles | per cell |
| Generic | | | | | 64 |
| Alternative | Normal | 143 | | 552 | 16 |
| | preamble | | | | |
| | Extended | 719 | | 718 | |
| | preamble | | | | |

The multiplexing between the different users is achieved through the code domain orthogonality. Cyclic shifts of Zadoff-Chu sequences are used as the orthogonal codes. The maximum number of orthogonal codes can be computed as above for the resource elements as 12*7=84. The orthogonality within a single block, or FDMA symbol, is limited by the channel delay spread and the sinc pulse shape used in the transceiver. Between the blocks the orthogonality is limited by the channel Doppler spread as well as the frequency error. In practice, the number of orthogonal codes can be less than 84 due to these phenomena.

### SUMMARY OF THE INVENTION

In this patent application, we refer to the different orthogonal codes by an index. An orthogonal code is a combination of spreading within the block and between the blocks. The index is determined by placing the different orthogonal codes in a vector and incrementing first the cyclic shifts between the blocks. An example for 3 cyclic shifts within a block and 7 cyclic shifts between blocks is given in FIG. 2.

For the cyclic shifts between the blocks, it is possible to select from six (1-6) different root Zadoff-Chu sequences. For the cyclic shifts within the blocks, a selection from four (1, 5, 7, 11) root sequences is made.

Current solutions do not show the performance of the code domain multiplexing scheme in a high speed environment, nor in environments with a high speed line-of-sight channel condition. These channel conditions cause a large degradation in performance. The performance falls to an unsatisfactory level, thus needing some corrective measures.

The invention is based on the observation that high Doppler frequencies as well as high frequency errors will cause a loss in the orthogonality between the otherwise orthogonal codes. The loss is due to side peaks appearing in the auto-correlation function. A regularity can be observed in the side peaks and the index of the codes which are most interfered by the side peaks.

Accounting for both positive and negative frequency errors is needed. The index is dependant on the root sequence used for spreading between the blocks as well as the actual index of the orthogonal code. These side peaks begin to “look like” other orthogonal codes, causing a sharp increase in false alarms.

Motivated by these observations, a method for reducing the set of orthogonal codes to mitigate the issue is proposed. For the different root sequences used for spreading between blocks, the main side peaks with reference to the actual orthogonal code index are listed.

For root sequence 1, the main side peaks are formed to indexes −1, +1, −6 and +6 relative to the used orthogonal code index. The actual index is determined as a modulus(L)+1 operation, where L is the total number of orthogonal codes being used.

For root sequence 2, the main side peaks are formed to indexes −4, +4, −3 and +3.

For root sequence 3, the main side peaks are formed to indexes −5, +5, −2 and +2.

For root sequence 4, the same rule as root sequence 3.

For root sequence 5, the same rule as root sequence 2.

For root sequence 6, the same rule as root sequence 1.

The invention is characterized by the following features:
1. Selecting a reduced set of orthogonal codes, where the main side peaks of any selected code will not cause interference to any other selected code.
2.The rule for selecting the codes is determined by the root sequence as listed above.
3.The size of the selected set can vary, but the largest set for each value of L, which fulfils the criteria is preferred.
4. Extending the reduced set of orthogonal codes by allowing a different set of codes to be used for every other frame period

It is to be understood that all presented exemplary embodiments may also be used in any suitable combination.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 shows code domain multiplexing and spreading.

FIG. 2 shows indexing of the orthogonal codes.

FIG. 3 shows a block diagram of a CAZAC sequence modulator suitable for use in implementing the method of the present invention.

FIG. 4 shows a system, according to the present invention.

FIG. 5 shows a signal processor suitable for use in the user equipment, in the base station, or both.

### DETAILED DESCRIPTION OF THE INVENTION

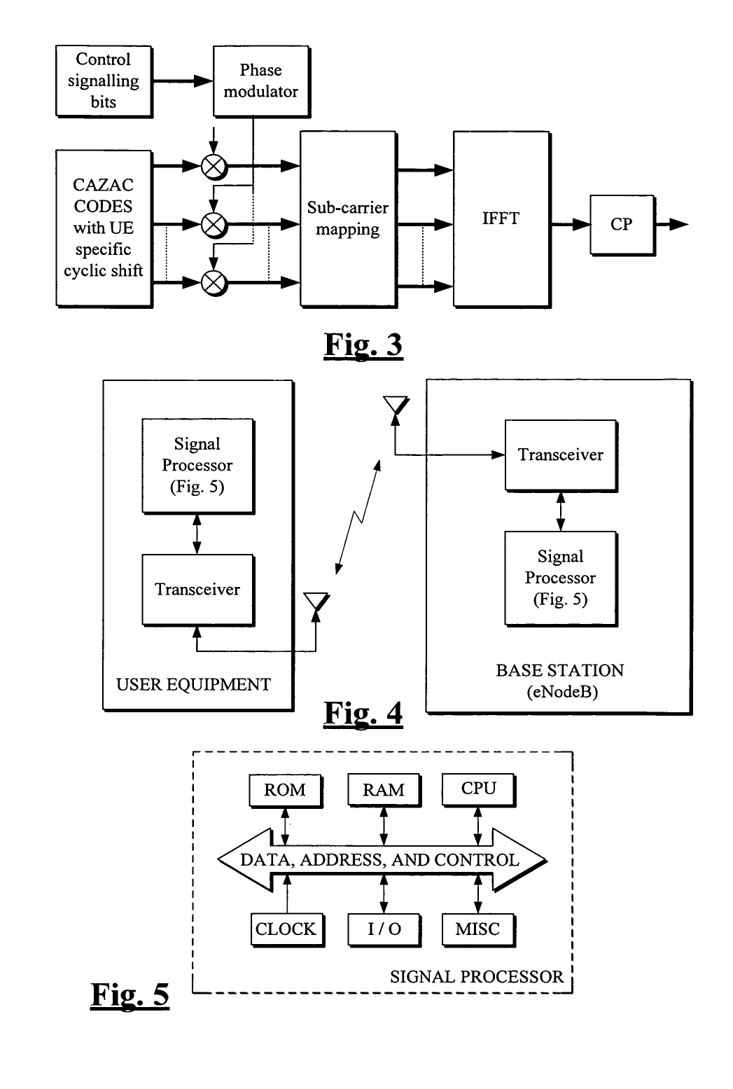

The transmitter in FIG. 3 will transmit, for each complex valued symbol within each SC-FDMA symbol, the result of a product of two elements of two different CAZAC sequences. These two CAZAC sequences are formed as cyclic shifts of CAZAC root sequences. The length of the first CAZAC sequence (sequence 1) is 12 and the length of the other sequence (sequence 2) is 7, in the LTE example. First the 12 elements of the CAZAC sequence 1 are formed. These elements are formed using a cyclic shift of a certain root sequence. 12 cyclic shifts are possible for this sequence. It is noted that in practice less than 12 can typically be used. Values of 6 and 3 are used in the examples described below. Root sequences 1,5,7 and 11 are possible (values of u previously described). The same values of sequence 1 are used for each SC-FDMA symbol in a slot for a single transmitter. Different transmitters within the same cell may use a different cyclic shift of the same root sequence. A different root sequence is typically used in a different cell. We call the combination of the two sequences an orthogonal code.

The scheduling request channel utilizes code domain multiplexing of different transmitters. Different cyclic shifts of the same CAZAC root sequences are typically used within the same cell, while different root sequences are typically used in different cells.

We give an identifier for the orthogonal code used by the transmitter. First we indicate the root sequence used for sequence 1 and sequence 2. Then we identify the cyclic shift used by sequence 1 and sequence 2. We give a value 1 for no shift, 2 for a shift by 1, etc. We note that a shift by the length of the sequence is equal to no shift.

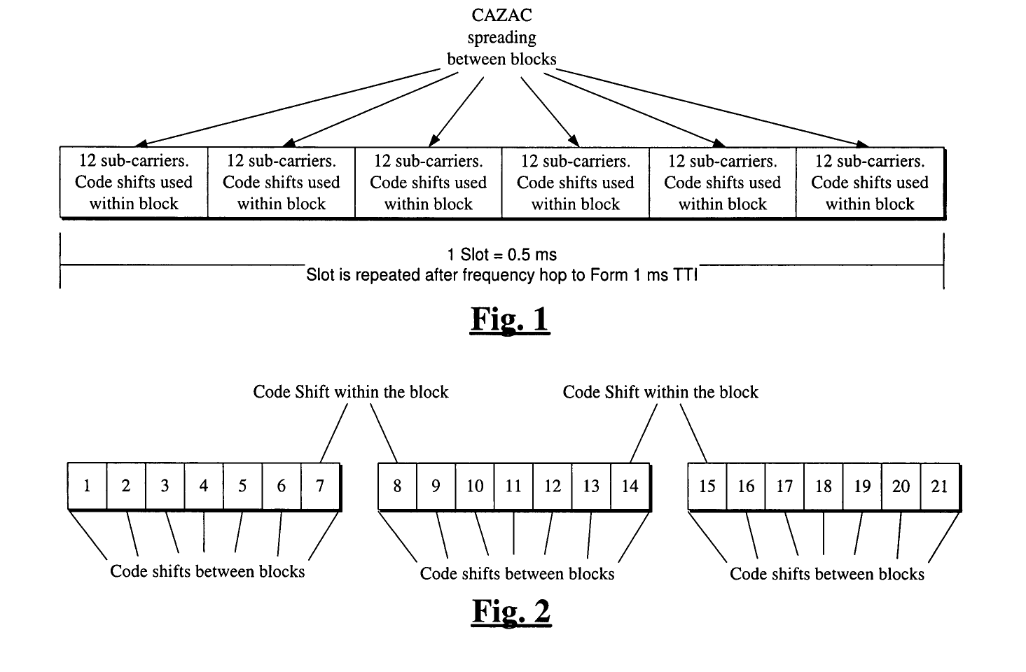

Referring to FIG. 2, we assign an index for the possible codes for any pair of root sequences. We first increment the cyclic shifts of sequence 2 and then the cyclic shifts of sequence 1. The indexing is shown in FIG. 2 for 3 cyclic shifts of sequence 1 and 7 cyclic shifts of sequence 2. This scheme is used to identify the code in describing the invention.

Without some special consideration, the performance of the transmitter scheme in a high Doppler channel or a channel with a high frequency error is poor. The invention provides a mechanism for improving the performance significantly in these conditions.

All sets of length 9, which fulfil the criteria, for L=21 is given (where L is the total number of orthogonal codes being used). Nine is the maximum number of sequences, which can be found for L=21. A similar table can be found for different values of L. The root sequence refers to the root sequence used for spreading between the blocks.

Root sequence 1:
For L = 21

| | | | | | | | | |
|---|---|---|---|---|---|---|---|---|
| 1 | 3 | 5 | 8 | 10 | 12 | 15 | 17 | 19 |
| 1 | 3 | 6 | 8 | 10 | 13 | 15 | 17 | 20 |
| 1 | 4 | 6 | 8 | 11 | 13 | 15 | 18 | 20 |
| 2 | 4 | 6 | 9 | 11 | 13 | 16 | 18 | 20 |
| 2 | 4 | 7 | 9 | 11 | 14 | 16 | 18 | 21 |
| 2 | 5 | 7 | 9 | 12 | 14 | 16 | 19 | 21 |
| 3 | 5 | 7 | 10 | 12 | 14 | 17 | 19 | 21 |

For L = 42

| | | | | | | | | |
|---|---|---|---|---|---|---|---|---|
| 1 | 3 | 5 | 8 | 10 | 12 | 15 | 17 | 19 |
| 22 | 24 | 26 | 29 | 31 | 33 | 36 | 38 | 40 |
| 1 | 3 | 6 | 8 | 10 | 13 | 15 | 17 | 20 |
| 22 | 24 | 27 | 29 | 31 | 34 | 36 | 38 | 41 |
| 1 | 4 | 6 | 8 | 11 | 13 | 15 | 18 | 20 |
| 22 | 25 | 27 | 29 | 32 | 34 | 36 | 39 | 41 |
| 2 | 4 | 6 | 9 | 11 | 13 | 16 | 18 | 20 |
| 23 | 25 | 27 | 30 | 32 | 34 | 37 | 39 | 41 |
| 2 | 4 | 7 | 9 | 11 | 14 | 16 | 18 | 21 |
| 23 | 25 | 28 | 30 | 32 | 35 | 37 | 39 | 42 |
| 2 | 5 | 7 | 9 | 12 | 14 | 16 | 19 | 21 |
| 23 | 26 | 28 | 30 | 33 | 35 | 37 | 40 | 42 |
| 3 | 5 | 7 | 10 | 12 | 14 | 17 | 19 | 21 |
| 24 | 26 | 28 | 31 | 33 | 35 | 38 | 40 | 42 |

Root sequence 2:
For L = 21

| | | | | | | | | |
|---|---|---|---|---|---|---|---|---|
| 1 | 2 | 3 | 8 | 9 | 10 | 15 | 16 | 17 |
| 1 | 2 | 7 | 8 | 9 | 14 | 15 | 16 | 21 |
| 1 | 6 | 7 | 8 | 13 | 14 | 15 | 20 | 21 |
| 2 | 3 | 4 | 9 | 10 | 11 | 16 | 17 | 18 |
| 3 | 4 | 5 | 10 | 11 | 12 | 17 | 18 | 19 |
| 4 | 5 | 6 | 11 | 12 | 13 | 18 | 19 | 20 |
| 5 | 6 | 7 | 12 | 13 | 14 | 19 | 20 | 21 |

For L = 42

| | | | | | | | | |
|---|---|---|---|---|---|---|---|---|
| 1 | 2 | 3 | 8 | 9 | 10 | 15 | 16 | 17 |
| 22 | 23 | 24 | 29 | 30 | 31 | 36 | 37 | 38 |
| 1 | 2 | 7 | 8 | 9 | 14 | 15 | 16 | 21 |
| 22 | 23 | 28 | 29 | 30 | 35 | 36 | 37 | 42 |
| 1 | 6 | 7 | 8 | 13 | 14 | 15 | 20 | 21 |
| 22 | 27 | 28 | 29 | 34 | 35 | 36 | 41 | 42 |
| 2 | 3 | 4 | 9 | 10 | 11 | 16 | 17 | 18 |
| 23 | 24 | 25 | 30 | 31 | 32 | 37 | 38 | 39 |
| 3 | 4 | 5 | 10 | 11 | 12 | 17 | 18 | 19 |
| 24 | 25 | 26 | 31 | 32 | 33 | 38 | 39 | 40 |
| 4 | 5 | 6 | 11 | 12 | 13 | 18 | 19 | 20 |
| 25 | 26 | 27 | 32 | 33 | 34 | 39 | 40 | 41 |
| 5 | 6 | 7 | 12 | 13 | 14 | 19 | 20 | 21 |
| 26 | 27 | 28 | 33 | 34 | 35 | 40 | 41 | 42 |

Root sequence 3:
For L = 21

| | | | | | | | | |
|---|---|---|---|---|---|---|---|---|
| 1 | 2 | 5 | 8 | 9 | 12 | 15 | 16 | 19 |
| 1 | 4 | 5 | 8 | 11 | 12 | 15 | 18 | 19 |
| 1 | 4 | 7 | 8 | 11 | 14 | 15 | 18 | 21 |
| 2 | 3 | 6 | 9 | 10 | 13 | 16 | 17 | 20 |
| 2 | 5 | 6 | 9 | 12 | 13 | 16 | 19 | 20 |
| 3 | 4 | 7 | 10 | 11 | 14 | 17 | 18 | 21 |
| 3 | 6 | 7 | 10 | 13 | 14 | 17 | 20 | 21 |

For L = 42

| | | | | | | | | |
|---|---|---|---|---|---|---|---|---|
| 1 | 2 | 5 | 8 | 9 | 12 | 15 | 16 | 19 |
| 22 | 23 | 26 | 29 | 30 | 33 | 36 | 37 | 40 |
| 1 | 4 | 5 | 8 | 11 | 12 | 15 | 18 | 19 |
| 22 | 25 | 26 | 29 | 32 | 33 | 36 | 39 | 40 |
| 1 | 4 | 7 | 8 | 11 | 14 | 15 | 18 | 21 |
| 22 | 25 | 28 | 29 | 32 | 35 | 36 | 39 | 42 |
| 2 | 3 | 6 | 9 | 10 | 13 | 16 | 17 | 20 |
| 23 | 24 | 27 | 30 | 31 | 34 | 37 | 38 | 41 |
| 2 | 5 | 6 | 9 | 12 | 13 | 16 | 19 | 20 |
| 23 | 26 | 27 | 30 | 33 | 34 | 37 | 40 | 41 |
| 3 | 4 | 7 | 10 | 11 | 14 | 17 | 18 | 21 |
| 24 | 25 | 28 | 31 | 32 | 35 | 38 | 39 | 42 |
| 3 | 6 | 7 | 10 | 13 | 14 | 17 | 20 | 21 |
| 24 | 27 | 28 | 31 | 34 | 35 | 38 | 41 | 42 |

Root sequence 4: (same as Root sequence 3)

Root sequence 5: (same as Root sequence 2)

Root sequence 6: (same as Root sequence 1)

FIG. 4 shows a system comprising user equipment and a base station (called “eNode B” in LTE). Both the user equipment and the base station include a transceiver and a signal processor. The signal processors may take various forms including but not limited to the form of processor shown in FIG. 5. Each transceiver is each coupled to an antenna and communications between the user equipment and the base station take place over a wireless interface. The scheduling request channel is an uplink channel within LTE. As such, the eNodeB defines to the UE how the channel should be used. The eNodeB will signal to the UE the orthogonal code to use when transmitting the scheduling request. The eNodeB will select the orthogonal code to use from the set defined by this application. The eNodeB will then receive the signal from the UE and detect the scheduling request by detecting the orthogonal code, which was transmitted by the UE.

The signal processor of the user equipment may take the form shown in FIG. 3 and as such comprises one or more functional blocks for selecting a reduced set of orthogonal codes such as the illustrated CAZAC codes, where main side peaks of any selected code will not cause interference to any other selected code, and for using the reduced set of orthogonal codes, according to the invention to spread the control signaling symbols and as exemplified above. The illustrated transceiver of the user equipment of course includes a transmitter for sending one or more scheduling requests block-wise spread with said reduced set of orthogonal codes.

The signal processor of the base station may also take the form shown in FIG. 5 and as such comprises a de-spreader for block de-spreading the symbol sequence sent by the UE with a reduced set of orthogonal codes and received by the base station. The illustrated transceiver of the base station of course includes a receiver for receiving the one or more scheduling requests block-wise spread with said reduced set of orthogonal codes. The signal processor of the base station may take a form similar to that shown in FIG. 3 except in reverse, for carrying out the de-spreading function.

FIG. 5 shows a general purpose signal processor suitable for carrying out the signal processing functions of FIG. 3 and as shown above for the UE and the reverse functions for the base station. It includes a read-only-memory (ROM), a random access memory (RAM), a central processing unit (CPU), a clock, an input/output (I/O) port, and miscellaneous functions, all interconnected by a data, address and control (DAC) bus. The ROM is a computer readable medium that is able to store program code written to carry out the various functions described above in conjunction with the RAM, CPU, I/O, etc. Of course, it should be realized that the same signal processing function may be carried out with a combination of hardware and software and may even be carried out entirely in hardware with a dedicated integrated circuit, i.e., without software.

What is claimed is:

1. Method comprising
selecting a reduced set of orthogonal codes, where main side peaks of any selected code will not cause interference to any other selected code, and
using the reduced set of orthogonal codes.

2. The method of claim 1 wherein a rule for selecting the reduced set of orthogonal codes is determined by a root sequence as listed below where L is the total number of orthogonal codes being used:
Root sequence 1:
For L = 21

| | | | | | | | | |
|---|---|---|---|---|---|---|---|---|
| 1 | 3 | 5 | 8 | 10 | 12 | 15 | 17 | 19 |
| 1 | 3 | 6 | 8 | 10 | 13 | 15 | 17 | 20 |
| 1 | 4 | 6 | 8 | 11 | 13 | 15 | 18 | 20 |
| 2 | 4 | 6 | 9 | 11 | 13 | 16 | 18 | 20 |
| 2 | 4 | 7 | 9 | 11 | 14 | 16 | 18 | 21 |
| 2 | 5 | 7 | 9 | 12 | 14 | 16 | 19 | 21 |
| 3 | 5 | 7 | 10 | 12 | 14 | 17 | 19 | 21 |

For L = 42

| | | | | | | | | |
|---|---|---|---|---|---|---|---|---|
| 1 | 3 | 5 | 8 | 10 | 12 | 15 | 17 | 19 |
| 22 | 24 | 26 | 29 | 31 | 33 | 36 | 38 | 40 |
| 1 | 3 | 6 | 8 | 10 | 13 | 15 | 17 | 20 |
| 22 | 24 | 27 | 29 | 31 | 34 | 36 | 38 | 41 |
| 1 | 4 | 6 | 8 | 11 | 13 | 15 | 18 | 20 |
| 22 | 25 | 27 | 29 | 32 | 34 | 36 | 39 | 41 |
| 2 | 4 | 6 | 9 | 11 | 13 | 16 | 18 | 20 |
| 23 | 25 | 27 | 30 | 32 | 34 | 37 | 39 | 41 |
| 2 | 4 | 7 | 9 | 11 | 14 | 16 | 18 | 21 |
| 23 | 25 | 28 | 30 | 32 | 35 | 37 | 39 | 42 |
| 2 | 5 | 7 | 9 | 12 | 14 | 16 | 19 | 21 |
| 23 | 26 | 28 | 30 | 33 | 35 | 37 | 40 | 42 |
| 3 | 5 | 7 | 10 | 12 | 14 | 17 | 19 | 21 |
| 24 | 26 | 28 | 31 | 33 | 35 | 38 | 40 | 42 |

Root sequence 2:
For L = 21

| | | | | | | | | |
|---|---|---|---|---|---|---|---|---|
| 1 | 2 | 3 | 8 | 9 | 10 | 15 | 16 | 17 |
| 1 | 2 | 7 | 8 | 9 | 14 | 15 | 16 | 21 |
| 1 | 6 | 7 | 8 | 13 | 14 | 15 | 20 | 21 |
| 2 | 3 | 4 | 9 | 10 | 11 | 16 | 17 | 18 |
| 3 | 4 | 5 | 10 | 11 | 12 | 17 | 18 | 19 |
| 4 | 5 | 6 | 11 | 12 | 13 | 18 | 19 | 20 |
| 5 | 6 | 7 | 12 | 13 | 14 | 19 | 20 | 21 |

For L = 42

| | | | | | | | | |
|---|---|---|---|---|---|---|---|---|
| 1 | 2 | 3 | 8 | 9 | 10 | 15 | 16 | 17 |
| 22 | 23 | 24 | 29 | 30 | 31 | 36 | 37 | 38 |
| 1 | 2 | 7 | 8 | 9 | 14 | 15 | 16 | 21 |
| 22 | 23 | 28 | 29 | 30 | 35 | 36 | 37 | 42 |
| 1 | 6 | 7 | 8 | 13 | 14 | 15 | 20 | 21 |
| 22 | 27 | 28 | 29 | 34 | 35 | 36 | 41 | 42 |
| 2 | 3 | 4 | 9 | 10 | 11 | 16 | 17 | 18 |
| 23 | 24 | 25 | 30 | 31 | 32 | 37 | 38 | 39 |
| 3 | 4 | 5 | 10 | 11 | 12 | 17 | 18 | 19 |
| 24 | 25 | 26 | 31 | 32 | 33 | 38 | 39 | 40 |
| 4 | 5 | 6 | 11 | 12 | 13 | 18 | 19 | 20 |
| 25 | 26 | 27 | 32 | 33 | 34 | 39 | 40 | 41 |
| 5 | 6 | 7 | 12 | 13 | 14 | 19 | 20 | 21 |
| 26 | 27 | 28 | 33 | 34 | 35 | 40 | 41 | 42 |

Root sequence 3:
For L = 21

| | | | | | | | | |
|---|---|---|---|---|---|---|---|---|
| 1 | 2 | 5 | 8 | 9 | 12 | 15 | 16 | 19 |
| 1 | 4 | 5 | 8 | 11 | 12 | 15 | 18 | 19 |
| 1 | 4 | 7 | 8 | 11 | 14 | 15 | 18 | 21 |
| 2 | 3 | 6 | 9 | 10 | 13 | 16 | 17 | 20 |
| 2 | 5 | 6 | 9 | 12 | 13 | 16 | 19 | 20 |
| 3 | 4 | 7 | 10 | 11 | 14 | 17 | 18 | 21 |
| 3 | 6 | 7 | 10 | 13 | 14 | 17 | 20 | 21 |

For L = 42

| | | | | | | | | |
|---|---|---|---|---|---|---|---|---|
| 1 | 2 | 5 | 8 | 9 | 12 | 15 | 16 | 19 |
| 22 | 23 | 26 | 29 | 30 | 33 | 36 | 37 | 40 |
| 1 | 4 | 5 | 8 | 11 | 12 | 15 | 18 | 19 |
| 22 | 25 | 26 | 29 | 32 | 33 | 36 | 39 | 40 |
| 1 | 4 | 7 | 8 | 11 | 14 | 15 | 18 | 21 |
| 22 | 25 | 28 | 29 | 32 | 35 | 36 | 39 | 42 |
| 2 | 3 | 6 | 9 | 10 | 13 | 16 | 17 | 20 |
| 23 | 24 | 27 | 30 | 31 | 34 | 37 | 38 | 41 |
| 2 | 5 | 6 | 9 | 12 | 13 | 16 | 19 | 20 |
| 23 | 26 | 27 | 30 | 33 | 34 | 37 | 40 | 41 |
| 3 | 4 | 7 | 10 | 11 | 14 | 17 | 18 | 21 |
| 24 | 25 | 28 | 31 | 32 | 35 | 38 | 39 | 42 |
| 3 | 6 | 7 | 10 | 13 | 14 | 17 | 20 | 21 |
| 24 | 27 | 28 | 31 | 34 | 35 | 38 | 41 | 42 |

Root sequence 4: (same as Root sequence 3)
Root sequence 5: (same as Root sequence 2)
Root sequence 6: (same as Root sequence 1).

3. The method of claim 2, wherein size of the selected set can vary, but a largest set for each value of L, which fulfils the criteria is selected.

4. The method of claim 1, wherein size of the selected set can vary, but a largest set for each value of L, which fulfills the criteria is selected, where L is a total number of orthogonal codes being used.

5. Apparatus configured to select a reduced set of orthogonal codes, where main side peaks of any selected code will not cause interference to any other selected code, and configured to use the reduced set of orthogonal codes.

2. The apparatus of claim 5, wherein a rule for selecting the reduced set of orthogonal codes is determined by a mother sequence as listed below, where L is a total number of orthogonal codes being used:
Root sequence 1:
For L = 21

| | | | | | | | | |
|---|---|---|---|---|---|---|---|---|
| 1 | 3 | 5 | 8 | 10 | 12 | 15 | 17 | 19 |
| 1 | 3 | 6 | 8 | 10 | 13 | 15 | 17 | 20 |
| 1 | 4 | 6 | 8 | 11 | 13 | 15 | 18 | 20 |
| 2 | 4 | 6 | 9 | 11 | 13 | 16 | 18 | 20 |
| 2 | 4 | 7 | 9 | 11 | 14 | 16 | 18 | 21 |
| 2 | 5 | 7 | 9 | 12 | 14 | 16 | 19 | 21 |
| 3 | 5 | 7 | 10 | 12 | 14 | 17 | 19 | 21 |

For L = 42

| | | | | | | | | |
|---|---|---|---|---|---|---|---|---|
| 1 | 3 | 5 | 8 | 10 | 12 | 15 | 17 | 19 |
| 22 | 24 | 26 | 29 | 31 | 33 | 36 | 38 | 40 |
| 1 | 3 | 6 | 8 | 10 | 13 | 15 | 17 | 20 |
| 22 | 24 | 27 | 29 | 31 | 34 | 36 | 38 | 41 |
| 1 | 4 | 6 | 8 | 11 | 13 | 15 | 18 | 20 |
| 22 | 25 | 27 | 29 | 32 | 34 | 36 | 39 | 41 |
| 2 | 4 | 6 | 9 | 11 | 13 | 16 | 18 | 20 |
| 23 | 25 | 27 | 30 | 32 | 34 | 37 | 39 | 41 |
| 2 | 4 | 7 | 9 | 11 | 14 | 16 | 18 | 21 |
| 23 | 25 | 28 | 30 | 32 | 35 | 37 | 39 | 42 |
| 2 | 5 | 7 | 9 | 12 | 14 | 16 | 19 | 21 |
| 23 | 26 | 28 | 30 | 33 | 35 | 37 | 40 | 42 |
| 3 | 5 | 7 | 10 | 12 | 14 | 17 | 19 | 21 |
| 24 | 26 | 28 | 31 | 33 | 35 | 38 | 40 | 42 |

Root sequence 2:
For L = 21

| | | | | | | | | |
|---|---|---|---|---|---|---|---|---|
| 1 | 2 | 3 | 8 | 9 | 10 | 15 | 16 | 17 |
| 1 | 2 | 7 | 8 | 9 | 14 | 15 | 16 | 21 |
| 1 | 6 | 7 | 8 | 13 | 14 | 15 | 20 | 21 |
| 2 | 3 | 4 | 9 | 10 | 11 | 16 | 17 | 18 |
| 3 | 4 | 5 | 10 | 11 | 12 | 17 | 18 | 19 |
| 4 | 5 | 6 | 11 | 12 | 13 | 18 | 19 | 20 |
| 5 | 6 | 7 | 12 | 13 | 14 | 19 | 20 | 21 |

For L = 42

| | | | | | | | | |
|---|---|---|---|---|---|---|---|---|
| 1 | 2 | 3 | 8 | 9 | 10 | 15 | 16 | 17 |
| 22 | 23 | 24 | 29 | 30 | 31 | 36 | 37 | 38 |
| 1 | 2 | 7 | 8 | 9 | 14 | 15 | 16 | 21 |
| 22 | 23 | 28 | 29 | 30 | 35 | 36 | 37 | 42 |
| 1 | 6 | 7 | 8 | 13 | 14 | 15 | 20 | 21 |
| 22 | 27 | 28 | 29 | 34 | 35 | 36 | 41 | 42 |
| 2 | 3 | 4 | 9 | 10 | 11 | 16 | 17 | 18 |
| 23 | 24 | 25 | 30 | 31 | 32 | 37 | 38 | 39 |
| 3 | 4 | 5 | 10 | 11 | 12 | 17 | 18 | 19 |
| 24 | 25 | 26 | 31 | 32 | 33 | 38 | 39 | 40 |
| 4 | 5 | 6 | 11 | 12 | 13 | 18 | 19 | 20 |
| 25 | 26 | 27 | 32 | 33 | 34 | 39 | 40 | 41 |
| 5 | 6 | 7 | 12 | 13 | 14 | 19 | 20 | 21 |
| 26 | 27 | 28 | 33 | 34 | 35 | 40 | 41 | 42 |

Root sequence 3:
For L = 21

| | | | | | | | | |
|---|---|---|---|---|---|---|---|---|
| 1 | 2 | 5 | 8 | 9 | 12 | 15 | 16 | 19 |
| 1 | 4 | 5 | 8 | 11 | 12 | 15 | 18 | 19 |
| 1 | 4 | 7 | 8 | 11 | 14 | 15 | 18 | 21 |
| 2 | 3 | 6 | 9 | 10 | 13 | 16 | 17 | 20 |
| 2 | 5 | 6 | 9 | 12 | 13 | 16 | 19 | 20 |
| 3 | 4 | 7 | 10 | 11 | 14 | 17 | 18 | 21 |
| 3 | 6 | 7 | 10 | 13 | 14 | 17 | 20 | 21 |

For L = 42

| | | | | | | | | |
|---|---|---|---|---|---|---|---|---|
| 1 | 2 | 5 | 8 | 9 | 12 | 15 | 16 | 19 |
| 22 | 23 | 26 | 29 | 30 | 33 | 36 | 37 | 40 |
| 1 | 4 | 5 | 8 | 11 | 12 | 15 | 18 | 19 |
| 22 | 25 | 26 | 29 | 32 | 33 | 36 | 39 | 40 |
| 1 | 4 | 7 | 8 | 11 | 14 | 15 | 18 | 21 |
| 22 | 25 | 28 | 29 | 32 | 35 | 36 | 39 | 42 |
| 2 | 3 | 6 | 9 | 10 | 13 | 16 | 17 | 20 |
| 23 | 24 | 27 | 30 | 31 | 34 | 37 | 38 | 41 |
| 2 | 5 | 6 | 9 | 12 | 13 | 16 | 19 | 20 |
| 23 | 26 | 27 | 30 | 33 | 34 | 37 | 40 | 41 |
| 3 | 4 | 7 | 10 | 11 | 14 | 17 | 18 | 21 |
| 24 | 25 | 28 | 31 | 32 | 35 | 38 | 39 | 42 |
| 3 | 6 | 7 | 10 | 13 | 14 | 17 | 20 | 21 |
| 24 | 27 | 28 | 31 | 34 | 35 | 38 | 41 | 42 |

Root sequence 4: (same as Root sequence 3)
Root sequence 5: (same as Root sequence 2)
Root sequence 6: (same as Root sequence 1).

7. The apparatus of claim 6, wherein size of the selected set can vary, but a largest set for each value of L, which fulfils the criteria is selected.

8. The apparatus of claim 5, wherein size of the selected set can vary, but a largest set for each value of L, which fulfils the criteria is selected, where L is a total number of orthogonal codes being used.
